(19) United States
(12) Patent Application Publication
(10) Pub. No.: US 2017/0342249 A1
(43) Pub. Date: Nov. 30, 2017

(54) Multilayer Films and Methods of Making the Same

(71) Applicant: ExxonMobil Chemical Patents Inc., Baytown, TX (US)

(72) Inventors: Bin Zhao, Shanghai (SG); Achiel J. M. Van Loon, Antwerp (BE)

(21) Appl. No.: 15/588,811

(22) Filed: May 8, 2017

Related U.S. Application Data
(60) Provisional application No. 62/341,881, filed on May 26, 2016.

(51) Int. Cl. C08L 23/14; B32B 27/08; C08L 23/08; B32B 7/02; B65D 75/00; C08J 5/18; B65D 65/40; B32B 27/32

(52) U.S. Cl. CPC C08L 23/14; B65D 65/40; B32B 27/08; B32B 27/327; B32B 7/02; B65D 75/006; C08J 5/18; C08L 23/0853; B32B 2274/00; B32B 2270/00; B32B 2250/242; B32B 2439/40; B32B 2307/72; B32B 2307/54; C08L 2207/066; C08J 2323/14; C08J 2423/08; C08J 2423/14; B32B 2307/51; C08L 2207/04; C08J 2323/08

(57) ABSTRACT

Disclosed are multilayer films which can provide desired performance suited to stretch hood applications.

### PRIORITY

This invention claims priority to and the benefit of U.S. Patent Application Ser. No. 62/341,881, filed May 26, 2016, which is herein incorporated by reference.

### FIELD OF THE INVENTION

This invention relates to films, and in particular, to multilayer films suitable for stretch hood applications, and methods for making such films.

### BACKGROUND OF THE INVENTION

Stretch hood packaging systems use a tubular film to bundle and protect goods. The goods may be a single item, such as a washing machine or refrigerator, or a collection of items, such as bottles, bags of soil, bags of polymer pellets, or concrete blocks. Often the goods are supported on a pallet or other supporting platform to form a palletized load which can be easily handled and transported with a forklift. A stretching device stretches the tubular film around the item or items to be packaged forming the stretch hood. As the stretching device releases the stretch hood, the elastic contraction of the film tube around the item(s) provides integrity and stability to the palletized load. The stretch hood can also act to protect and shield the palletized load from damage and environmental factors (e.g., moisture) during transportation and storage. Moreover, the elastic properties of the pallet stretch hood enable it to stabilize goods of different shapes and sizes.

Different film tube structures have been suggested for stretch hood. For example, PCT application WO 00/37543 discloses a three-layer film for stretch hood packaging using a blend of a metallocene produced plastomer and a predominant amount of ethylene (E) vinyl acetate (VA) with a high amount of VA in a core layer and surface layers of an EVA with low VA content containing SiO₂ as anti-block friction modifier.

PCT Publication WO 2005/014672 provides multilayer stretch hood films comprising a core layer containing EVA having a low vinyl acetate content and skin layers comprising linear low density polyethylene.

PCT Publication WO 2006/076917 discloses stretch hoods formed from a biaxially oriented tubular film having a seam. The tubular film may comprise a core layer of an EVA and skin layers of linear low density polyethylene or EVA.

PCT Publication WO 2007/044544 discloses multilayer elastic air quenched blown film structures having at least two layers. The first layer incorporates a propylene-based copolymer and optionally, a linear low density polyethylene or a low density polyethylene. The second layer incorporates a linear low density polyethylene and optionally, a propylene-based copolymer and/or a low density polyethylene. Alternatively, the second layer may contain an in-reactor blend of a substantially linear polyethylene (or a homogeneously branched linear polyethylene) and a linear low density polyethylene.

U.S. Pat. No. 8,225,584 provides films for stretch hood applications wherein at least one layer of the film comprises a first polymer component and a second polymer component. The first polymer component comprises propylene-derived units and ethylene-derived units and/or a C4 to C20 alpha-olefin. The second polymer component comprises ethylene-derived units and a units derived from a co-polymerizable ethylenically unsaturated ester.

U.S. Patent Application Publication No. 2015/0258754 relates to multilayer films for stretch hood applications comprising one or more intermediate layers including a blend of propylene-based elastomer and a linear low density polyethylene.

Generally, previous efforts in the art mostly focus on point-by-point improvements on the conventional three-layer structure and compositions made of EVA and/or other polyethylenes in specific layers. However, use of EVA in the core layer limits elasticity of the film hood, which means the film is easily stretched but only exerts a limited force to return to its pre-stretched state. The film holding force may also be weakened. These drawbacks can only be partially compensated by addition of other polyethylenes. The surface friction provided by EVA skin layers, generally having a broad molecular weight distribution, can only be controlled by high amounts of anti-block, which has a negative effect on the transparency and mechanical properties. Efforts to remedy the situation include introduction of propylene-based elastomer into the film core layer. Despite increase in elasticity and toughness of the film, addition of propylene-based elastomer with removal of EVA may lead to reduced bubble stability and processability during blown extrusion. It is also difficult to obtain desired stretchability tailored to machine and hand stretch hood films, respectively. Propylene-based elastomer's role in facilitating improvement on and balance between properties has been limited by the conventional film design.

Accordingly, there remains a need for a stretch hood film that has enhanced properties and overall performance in stretch hood packaging systems. The inventors have found that such objective can be achieved by adjusting structure and composition of a film having at least three layers depending on the ethylene content level of the propylene-based elastomer employed in the film. Particularly, neat propylene-based elastomer is applied to the core layer when the propylene-based elastomer has an ethylene content of 13 wt % (based on total weight of the propylene-based elastomer) or more, while a polyethylene having a specific branching index is added into the core layer to blend with propylene-based elastomer present in an amount of at least about 50 wt % (based on total weight of polymer in the core layer) when the propylene-based elastomer has an ethylene content of no more than 13 wt %. Preferably, in cases where two inner layers each between the core layer and each outer layer are present, composition of the inner layers can vary in step with the core layer, to be either propylene-based elastomer rich (50 wt % or more) or propylene-based elastomer lean (no more than 50 wt %). Without being restricted by use of EVA and the current three-layer structure, using a propylene-based elastomer with a selected ethylene content level, optionally aided by the inner layers between the core layer and each outer layer and the polyethylene in blend with the propylene-based elastomer in the core layer, the inventive film can conveniently deliver improved elasticity, toughness, elastic recovery, stretchability, holding force, and processability, thus resulting in a better-balanced overall performance favored by stretch hood applications. Desirably, the film can provide package integrity and transparency, resistance to puncture and tearing, and/or reduced stress relaxation at higher ambient temperatures after the stretch hood packaging operation has been completed. Additionally, the film can demonstrate increased elasticity and holding force enough to contain the palletized goods but not so high as to damage the items on the palletized load. Moreover, the film can achieve soft stretchability required by hand stretch hood film to enable manually stretching the film tube to a predetermined extent, e.g. 10% to 20%.

### SUMMARY OF THE INVENTION

In one aspect, embodiments described herein encompass a multilayer film, comprising: (a) two outer layers, wherein at least one of the outer layers comprises a first polyethylene; and (b) a core layer between the two outer layers, comprising a first propylene-based elastomer having at least about 60 wt % propylene-derived units and about 3 to about 25 wt % ethylene-derived units, based on total weight of the first propylene-based elastomer, and a heat of fusion of less than about 80 J/g, wherein the first propylene-based elastomer is present in an amount of at least 50 wt %, based on total weight of polymer in the core layer, wherein the multilayer film has at least one of the following properties: (i) a tensile at break of at least about 40 MPa in the Machine Direction (MD) and of at least about 38 MPa in the Transverse Direction (TD); (ii) a tear propagation of less than or equal to about 10%; (iii) an elastic recovery of at least about 55%; (iv) a holding force (normalized to 100 μm end) of at least about 22 N/μm; (v) a maximum force at 100% strain of less than or equal to about 0.2 N/μm; and (vi) a tear resistance of at least about 12 g/μm in MD.

### DETAILED DESCRIPTION OF THE PRESENT INVENTION

Various specific embodiments, versions of the present invention will now be described, including preferred embodiments and definitions that are adopted herein. While the following detailed description gives specific preferred embodiments, those skilled in the art will appreciate that these embodiments are exemplary only, and that the present invention can be practiced in other ways. Any reference to the “invention” may refer to one or more, but not necessarily all, of the present inventions defined by the claims. The use of headings is for purposes of convenience only and does not limit the scope of the present invention.

As used herein, a “polymer” may be used to refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like. Thus, as used herein, the terms “polyethylene,” “ethylene polymer,” “ethylene copolymer,” and “ethylene based polymer” mean a polymer or copolymer comprising at least 50 mol % ethylene units (preferably at least 70 mol % ethylene units, more preferably at least 80 mol % ethylene units, even more preferably at least 90 mol % ethylene units, even more preferably at least 95 mol % ethylene units or 100 mol % ethylene units (in the case of a homopolymer)). Furthermore, the term “polyethylene composition” means a composition containing one or more polyethylene components.

As used herein, when a polymer is referred to as comprising a monomer, the monomer is present in the polymer in the polymerized form of the monomer or in the derivative form of the monomer.

As used herein, when a polymer is said to comprise a certain percentage, wt %, of a monomer, that percentage of monomer is based on the total amount of monomer units in the polymer.

For purposes of this invention and the claims thereto, an ethylene polymer having a density of 0.910 to 0.940 g/cm³ is referred to as a “low density polyethylene” (LDPE); an ethylene polymer having a density of 0.890 to 0.930 g/cm³, typically from 0.910 to 0.930 g/cm³, that is linear and does not contain a substantial amount of long-chain branching is referred to as “linear low density polyethylene” (LLDPE) and can be produced with conventional Ziegler-Natta catalysts, vanadium catalysts, or with metallocene catalysts in gas phase reactors, high pressure tubular reactors, and/or in slurry reactors and/or with any of the disclosed catalysts in solution reactors (“linear” means that the polyethylene has no or only a few long-chain branches, typically referred to as a g′ᵥᵢₛ of 0.97 or above, preferably 0.98 or above); and an ethylene polymer having a density of more than 0.940 g/cm³ is referred to as a “high density polyethylene” (HDPE).

As used herein, “elastomer” or “elastomer composition” refers to any polymer or composition of polymers (such as blends of polymers) consistent with the ASTM D1566 definition. Elastomer includes mixed blends of polymers such as melt mixing and/or reactor blends of polymers.

As used herein, “core” layer, “outer” layer, and “inner” layer are merely identifiers used for convenience, and shall not be construed as limitation on individual layers, their relative positions, or the laminated structure, unless otherwise specified herein.

As used herein, “first” polyethylene, “second” polyethylene, “third” polyethylene, “first” propylene-based elastomer, and “second” propylene-based elastomer are merely identifiers used for convenience, and shall not be construed as limitation on individual polyethylene or propylene-based elastomer, their relative order, or the number of polyethylenes or propylene-based elastomers used, unless otherwise specified herein.

As used herein, film layers that are the same in composition and in thickness are referred to as “identical” layers.

### Propylene-Based Elastomer

The propylene-based elastomer useful in the multilayer film described herein is a copolymer of propylene-derived units and units derived from at least one of ethylene or a C₄-C₁₀ alpha-olefin. The propylene-based elastomer may contain at least about 50 wt % propylene-derived units. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The amount of propylene-derived units present in the propylene-based elastomer may range from an upper limit of about 95 wt %, about 94 wt %, about 92 wt %, about 90 wt %, or about 85 wt %, to a lower limit of about 60 wt %, about 65 wt %, about 70 wt %, about 75 wt %, about 80 wt %, about 84 wt %, or about 85 wt %, of the propylene-based elastomer.

The units, or comonomers, derived from at least one of ethylene or a C₄-C₁₀ alpha-olefin may be present in an amount of about 1 to about 35 wt %, or about 5 to about 35 wt %, or about 7 to about 30 wt %, or about 8 to about 25 wt %, or about 8 to about 20 wt %, or about 8 to about 18 wt %, of the propylene-based elastomer. The comonomer content may be adjusted so that the propylene-based elastomer has a heat of fusion of less than about 80 J/g, a melting point of about 105° C. or less, and a crystallinity of about 2% to about 65% of the crystallinity of isotactic polypropylene, and a fractional melt mass-flow rate of about 0.5 to about 20 g/min.

In preferred embodiments, the comonomer is ethylene, 1-hexene, or 1-octene, with ethylene being most preferred. In embodiments where the propylene-based elastomer comprises ethylene-derived units, the propylene-based elastomer may comprise about 3 to about 25 wt %, or about 5 to about 20 wt %, or about 9 to about 18 wt % of ethylene-derived units. In some embodiments, the propylene-based elastomer consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the heat of fusion, melting point, crystallinity, or fractional melt mass-flow rate of the propylene-based elastomer, or in an amount such that any other comonomer is intentionally added to the polymerization process.

In some embodiments, the propylene-based elastomer may comprise more than one comonomer. Preferred embodiments of a propylene-based elastomer having more than one comonomer include propylene-ethylene-octene, propylene-ethylene-hexene, and propylene-ethylene-butene polymers. In embodiments where more than one comonomer derived from at least one of ethylene or a C₄-C₁₀ alpha-olefin is present, the amount of one comonomer may be less than about 5 wt % of the propylene-based elastomer, but the combined amount of comonomers of the propylene-based elastomer is about 5 wt % or greater.

The propylene-based elastomer may have a triad tacticity of three propylene units, as measured by ¹³C NMR, of at least about 75%, at least about 80%, at least about 82%, at least about 85%, or at least about 90%. Preferably, the propylene-based elastomer has a triad tacticity of about 50 to about 99%, or about 60 to about 99%, or about 75 to about 99%, or about 80 to about 99%. In some embodiments, the propylene-based elastomer may have a triad tacticity of about 60 to 97%.

The propylene-based elastomer has a heat of fusion (“H_{f}”), as determined by DSC, of about 80 J/g or less, or about 70 J/g or less, or about 50 J/g or less, or about 40 J/g or less. The propylene-based elastomer may have a lower limit H_{f} of about 0.5 J/g, or about 1 J/g, or about 5 J/g. For example, the H_{f} value may range from a lower limit of about 1.0, 1.5, 3.0, 4.0, 6.0, or 7.0 J/g, to an upper limit of about 35, 40, 50, 60, 70, 75, or 80 J/g.

The propylene-based elastomer may have a percent crystallinity, as determined according to ASTM D3418-03 with a 10° C./min heating/cooling rate, of about 2 to about 65%, or about 0.5 to about 40%, or about 1 to about 30%, or about 5 to about 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25 to about 25%, or in the range of about 0.5 to about 22%, of the crystallinity of isotactic polypropylene.

Embodiments of the propylene-based elastomer may have a tacticity index m/r from a lower limit of about 4, or about 6, to an upper limit of about 8, or about 10, or about 12. In some embodiments, the propylene-based elastomer has an isotacticity index greater than 0%, or within the range having an upper limit of about 50%, or about 25%, and a lower limit of about 3%, or about 10%.

In some embodiments, the propylene-based elastomer may further comprise diene-derived units (as used herein, “diene”). The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkylene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of about 15%, about 10%, about 7%, about 5%, about 4.5%, about 3%, about 2.5%, or about 1.5%, to a lower limit of about 0%, about 0.1%, about 0.2%, about 0.3%, about 0.5%, about 1%, about 3%, or about 5%, based on the total weight of the propylene-based elastomer.

The propylene-based elastomer may have a single peak melting transition as determined by DSC. In some embodiments, the copolymer has a primary peak transition of about 90° C. or less, with a broad end-of-melt transition of about 110° C. or greater. The peak “melting point” (“Tₘ”) is defined as the temperature of the greatest heat absorption within the range of melting of the sample. However, the copolymer may show secondary melting peaks adjacent to the principal peak, and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of about 110° C. or less, about 105° C. or less, about 100° C. or less, about 90° C. or less, about 80° C. or less, or about 70° C. or less. In some embodiments, the propylene-based elastomer has a Tₘ of about 25 to about 110° C., or about 40 to about 105° C., or about 60 to about 105° C. Tm of the propylene-based elastomer can be determined by ASTM D3418-03 with a 10° C./min heating/cooling rate.

The propylene-based elastomer may have a density of about 0.850 to about 0.900 g/cm³, or about 0.860 to about 0.880 g/cm³, at room temperature as measured based on ASTM D1505.

The propylene-based elastomer may have a fractional melt mass-flow rate (MFR), as measured based on ASTM D1238, 2.16 kg at 230° C., of at least about 0.5 g/10 min In some embodiments, the propylene-based elastomer may have a fractional MFR of about 0.5 to about 20 g/10 min, or about 2 to about 18 g/10 min.

The propylene-based elastomer may have an Elongation at Break of less than about 2000%, less than about 1800%, less than about 1500%, or less than about 1000%, as measured based on ASTM D638.

The propylene-based elastomer may have a weight average molecular weight (M_{w}) of about 5,000 to about 5,000,000 g/mol, or about 10,000 to about 1,000,000 g/mol, or about 50,000 to about 400,000 g/mol. The propylene-based elastomer may have a number average molecular weight (Mₙ) of about 2,500 to about 250,000 g/mol, or about 10,000 to about 250,000 g/mol, or about 25,000 to about 250,000 g/mol. The propylene-based elastomer may have a z-average molecular weight (M_{z}) of about 10,000 to about 7,000,000 g/mol, or about 80,000 to about 700,000 g/mol, or about 100,000 to about 500,000 g/mol.

The propylene-based elastomer may have a molecular weight distribution (“MWD”) of about 1.5 to about 20, or about 1.5 to about 15, or about 1.5 to about 5, or about 1.8 to about 3, or about 1.8 to about 2.5.

Weight-average molecular weight, M_{w}, molecular weight distribution (MWD) or M_{w}/Mₙ where Mₙ is the number-average molecular weight, and the branching index, g′(vis), are characterized using a High Temperature Size Exclusion Chromatograph (SEC), equipped with a differential refractive index detector (DRI), an online light scattering detector (LS), and a viscometer. Experimental details not shown below, including how the detectors are calibrated, are described in: T. Sun, P. Brant, R. R. Chance, and W. W. Graessley, Macromolecules, Volume 34, Number 19, pp. 6812-6820, 2001. In one or more embodiments, the polymer blend can have a polydispersity index of from about 1.5 to about 6.

Solvent for the SEC experiment is prepared by dissolving 6 g of butylated hydroxy toluene as an antioxidant in 4 L of Aldrich reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hr. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample the DRI detector and the injector are purged. Flow rate in the apparatus is then increased to 0.5 mL/min, and the DRI was allowed to stabilize for 8-9 hr before injecting the first sample. The LS laser is turned on 1 to 1.5 hr before running samples. As used herein, the term “room temperature” is used to refer to the temperature range of about 20° C. to about 23.5° C.

The concentration, c, at each point in the chromatogram is calculated from the baseline-subtracted DRI signal, I_{DRI}, using the following equation:

c=K_{DRI}I_{DRI}/(dn/dc)

where K_{DRI} is a constant determined by calibrating the DRI, and dn/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

[Kₒc/ΔR(θ,c)]=[1/MP(θ)]+2A₂c

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and Kₒ is the optical constant for the system:

$${K}_{o} = \frac{4 {π}^{2} {{n}^{2} ( dn / dc )}^{2}}{{λ}^{4} {N}_{A}}$$

in which N_{A} is the Avogadro's number, and dn/dc is the refractive index increment for the system. The refractive index, n=1.500 for TCB at 135° C. and λ=690 nm. In addition, A₂=0.0015 and dn/dc=0.104 for ethylene polymers, whereas A₂=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

M_{w}=ΣwᵢMᵢ=(ΣNᵢMᵢ²/ΣNᵢMᵢ)

since the weight fraction wᵢ is defined as the weight of molecules of molecular weight Mᵢ divided by the total weight of all the molecules present:

wᵢ=NᵢMᵢ/ΣNᵢMᵢ

The number-average molecular weight, Mₙ, is defined as the sum of the products of the molecular weight Mᵢ of each fraction multiplied by its mole fraction xᵢ:

Mₙ=ΣxᵢMᵢ=ΣNᵢMᵢ/ΣNᵢ

since the mole fraction xᵢ is defined as Nᵢ divided by the total number of molecules:

xᵢ=Nᵢ/ΣNᵢ.

In the SEC, a high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c was determined from the DRI output.

The branching index (g′, also referred to as g′(vis)) is calculated using the output of the SEC-DRI-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′ is defined as:

$${g}^{′} = \frac{{[ η ]}_{avg}}{{kM}_{v}^{α}}$$

where k=0.000579 and α=0.695 for ethylene polymers; k=0.0002288 and α=0.705 for propylene polymers; and k=0.00018 and α=0.7 for butene polymers.

Mᵥ is the viscosity-average molecular weight based on molecular weights determined by the LS analysis:

Mᵥ≡(ΣcᵢMᵢ^{α}/Σcᵢ)^{1/α}.

Suitable propylene-based elastomers may be available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins, Netherlands). The particular grade(s) of commercially available propylene-based elastomer suitable for use in the invention can be readily determined using methods commonly known in the art.

In one embodiment of the present invention, the multilayer film described herein comprises in the core layer a first propylene-based elastomer (as a propylene-based elastomer defined herein) having at least about 60 wt % propylene-derived units and about 3 to about 25 wt % ethylene-derived units, based on total weight of the first propylene-based elastomer, and a heat of fusion of less than about 80 J/g. Specifically, the first propylene-based elastomer may be an elastomer consisting essentially of units derived from propylene and ethylene, including propylene-crystallinity, a melting point by DSC equal to or less than 105° C., and a heat of fusion of from about 5 J/g to about 35 J/g. The propylene-derived units are present in an amount of about 80 to about 90 wt %, based on the total weight of the first propylene-based elastomer. The ethylene-derived units are present in an amount of about 8 to about 18 wt %, for example, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5, about 18 wt %, based on the total weight of the first propylene-based elastomer.

In a preferred embodiment where the multilayer film described herein further comprises two inner layers each between the core layer and each outer layer, at least one of the inner layer comprises a second propylene-based elastomer (as a propylene-based elastomer defined herein) having at least about 60 wt % propylene-derived units and about 3 to about 25 wt % ethylene-derived units, based on total weight of the second propylene-based elastomer, and a heat of fusion of less than about 80 J/g. The second propylene-based elastomer may be the same as or different from the first propylene-based elastomer. Preferably, the second propylene-based elastomer is the same as the first propylene-based elastomer.

The first propylene-based elastomer in the core layer and optionally the second propylene-based elastomer in at least one of the inner layers (if present) in the multilayer film described herein may be optionally in a blend with one or more other polymers, such as propylene-based elastomers defined herein, which blend is referred to as propylene-based elastomer composition. The propylene-based elastomer composition may include one or more different propylene-based elastomers, i.e., propylene-based elastomers each having one or more different properties such as, for example, different comonomer or comonomer content. Such combinations of various propylene-based elastomers are all within the scope of the invention.

### Polyethylene

In one aspect of the invention, the polyethylene that can be used for the multilayer film described herein are selected from ethylene homopolymers, ethylene copolymers, and compositions thereof. Useful copolymers comprise one or more comonomers in addition to ethylene and can be a random copolymer, a statistical copolymer, a block copolymer, and/or compositions thereof. The method of making the polyethylene is not critical, as it can be made by slurry, solution, gas phase, high pressure or other suitable processes, and by using catalyst systems appropriate for the polymerization of polyethylenes, such as Ziegler-Natta-type catalysts, chromium catalysts, metallocene-type catalysts, other appropriate catalyst systems or combinations thereof, or by free-radical polymerization. In a preferred embodiment, the polyethylenes are made by the catalysts, activators and processes described in U.S. Pat. Nos. 6,342,566; 6,384,142; and 5,741,563; and WO 03/040201 and WO 97/19991. Such catalysts are well known in the art, and are described in, for example, ZIEGLER CATALYSTS (Gerhard Fink, Rolf Müllhaupt and Hans H. Brintzinger, eds., Springer-Verlag 1995); Resconi et al.; and I, II METALLOCENE-BASED POLYOLEFINS (Wiley & Sons 2000).

Polyethylenes that are useful in this invention include those sold by ExxonMobil Chemical Company in Houston, Tex., including HDPE, LLDPE, and LDPE; and those sold under the ENABLE™, EXACT™, EXCEED™, ESCORENE™, EXXCO™, ESCOR™, PAXON™, and OPTEMA™ tradenames

Preferred ethylene homopolymers and copolymers useful in this invention typically have one or more of the following properties:

1. an M_{w} of 20,000 g/mol or more, 20,000 to 2,000,000 g/mol, preferably 30,000 to 1,000,000, preferably 40,000 to 200,000, preferably 50,000 to 750,000, as determined by the method described herein; and/or

2. a Tₘ of 30° C. to 150° C., preferably 30° C. to 140° C., preferably 50° C. to 140° C., more preferably 60° C. to 135° C., as determined based on ASTM D3418-03 with a heating/cooling rate of 10° C./min; and/or

3. a crystallinity of 5% to 80%, preferably 10% to 70%, more preferably 20% to 60%, preferably at least 30%, or at least 40%, or at least 50%, as determined based on ASTM D3418-03 with a heating/cooling rate of 10° C./min; and/or

4. a heat of fusion of 300 J/g or less, preferably 1 to 260 J/g, preferably 5 to 240 J/g, preferably 10 to 200 J/g, as determined based on ASTM D3418-03 with a heating/cooling rate of 10° C./min; and/or

5. a crystallization temperature (T_{c}) of 15° C. to 130° C., preferably 20° C. to 120° C., more preferably 25° C. to 110° C., preferably 60° C. to 125° C., as determined based on ASTM D3418-03 with a heating/cooling rate of 10° C./min; and/or

6. a heat deflection temperature of 30° C. to 120° C., preferably 40° C. to 100° C., more preferably 50° C. to 80° C. as measured based on ASTM D648 on injection molded flexure bars, at 66 psi load (455 kPa); and/or

7. a Shore hardness (D scale) of 10 or more, preferably 20 or more, preferably 30 or more, preferably 40 or more, preferably 100 or less, preferably from 25 to 75 (as measured based on ASTM D 2240); and/or

8. a percent amorphous content of at least 50%, preferably at least 60%, preferably at least 70%, more preferably between 50% and 95%, or 70% or less, preferably 60% or less, preferably 50% or less as determined by subtracting the percent crystallinity from 100.

The polyethylene may be an ethylene homopolymer, such as HDPE. In one embodiment, the ethylene homopolymer has a molecular weight distribution (M_{w}/Mₙ) or (MWD) of up to 40, preferably ranging from 1.5 to 20, or from 1.8 to 10, or from 1.9 to 5, or from 2.0 to 4. In another embodiment, the 1% secant flexural modulus (determined based on ASTM D790A, where test specimen geometry is as specified under the ASTM D790 section “Molding Materials (Thermoplastics and Thermosets),” and the support span is 2 inches (5.08 cm)) of the polyethylene falls in a range of 200 to 1000 MPa, and from 300 to 800 MPa in another embodiment, and from 400 to 750 MPa in yet another embodiment, wherein a desirable polymer may exhibit any combination of any upper flexural modulus limit with any lower flexural modulus limit. The MI of preferred ethylene homopolymers range from 0.05 to 800 dg/min in one embodiment, and from 0.1 to 100 dg/min in another embodiment, as measured based on ASTM D1238 (190° C., 2.16 kg).

In a preferred embodiment, the polyethylene comprises less than 20 mol % propylene units (preferably less than 15 mol %, preferably less than 10 mol %, preferably less than 5 mol %, and preferably 0 mol % propylene units).

In another embodiment of the invention, the polyethylene useful herein is produced by polymerization of ethylene and, optionally, an alpha-olefin with a catalyst having, as a transition metal component, a bis (n-C34 alkyl cyclopentadienyl) hafnium compound, wherein the transition metal component preferably comprises from 95 mol % to about 99 mol % of the hafnium compound as further described in U.S. Pat. No. 9,956,088.

In another embodiment of the invention, the polyethylene is an ethylene copolymer, either random or block, of ethylene and one or more comonomers selected from C₃ to C₂₀ α-olefins, typically from C₃ to C₁₀ α-olefins. Preferably, the comonomers are present from 0.1 wt % to 50 wt % of the copolymer in one embodiment, and from 0.5 wt % to 30 wt % in another embodiment, and from 1 wt % to 15 wt % in yet another embodiment, and from 0.1 wt % to 5 wt % in yet another embodiment, wherein a desirable copolymer comprises ethylene and C₃ to C₂₀ α-olefin derived units in any combination of any upper wt % limit with any lower wt % limit described herein. Preferably, the ethylene copolymer will have a weight average molecular weight of from greater than 8,000 g/mol in one embodiment, and greater than 10,000 g/mol in another embodiment, and greater than 12,000 g/mol in yet another embodiment, and greater than 20,000 g/mol in yet another embodiment, and less than 1,000,000 g/mol in yet another embodiment, and less than 800,000 g/mol in yet another embodiment, wherein a desirable copolymer may comprise any upper molecular weight limit with any lower molecular weight limit described herein.

In another embodiment, the ethylene copolymer comprises ethylene and one or more other monomers selected from the group consisting of C₃ to C₂₀ linear, branched or cyclic monomers, and in some embodiments is a C₃ to C₁₂ linear or branched alpha-olefin, preferably butene, pentene, hexene, heptene, octene, nonene, decene, dodecene, 4-methyl-pentene-1,3-methyl pentene-1,3,5,5-trimethyl-hexene-1, and the like. The monomers may be present at up to 50 wt %, preferably from up to 40 wt %, more preferably from 0.5 wt % to 30 wt %, more preferably from 2 wt % to 30 wt %, more preferably from 5 wt % to 20 wt %, based on the total weight of the ethylene copolymer.

Preferred linear alpha-olefins useful as comonomers for the ethylene copolymers useful in this invention include C₃ to C₈ alpha-olefins, more preferably 1-butene, 1-hexene, and 1-octene, even more preferably 1-hexene. Preferred branched alpha-olefins include 4-methyl-1-pentene, 3-methyl-1-pentene, 3,5,5-trimethyl-1-hexene, and 5-ethyl-1-nonene. Preferred aromatic-group-containing monomers contain up to 30 carbon atoms. Suitable aromatic-group-containing monomers comprise at least one aromatic structure, preferably from one to three, more preferably a phenyl, indenyl, fluorenyl, or naphthyl moiety. The aromatic-group-containing monomer further comprises at least one polymerizable double bond such that after polymerization, the aromatic structure will be pendant from the polymer backbone. The aromatic-group containing monomer may further be substituted with one or more hydrocarbyl groups including but not limited to C₁ to C₁₀ alkyl groups. Additionally, two adjacent substitutions may be joined to form a ring structure. Preferred aromatic-group-containing monomers contain at least one aromatic structure appended to a polymerizable olefinic moiety. Particularly, preferred aromatic monomers include styrene, alpha-methylstyrene, para-alkylstyrenes, vinyltoluenes, vinylnaphthalene, allyl benzene, and indene, especially styrene, paramethyl styrene, 4-phenyl-1-butene and allyl benzene.

Preferred diolefin monomers useful in this invention include any hydrocarbon structure, preferably C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene, or higher ring containing diolefins with or without substituents at various ring positions.

In a preferred embodiment, one or more dienes are present in the polyethylene at up to 10 wt %, preferably at 0.00001 wt % to 2 wt %, preferably 0.002 wt % to 1 wt %, even more preferably 0.003 wt % to 0.5 wt %, based upon the total weight of the polyethylene. In some embodiments, diene is added to the polymerization in an amount of from an upper limit of 500 ppm, 400 ppm, or 300 ppm to a lower limit of 50 ppm, 100 ppm, or 150 ppm.

Preferred ethylene copolymers useful herein are preferably a copolymer comprising at least 50 wt % ethylene and having up to 50 wt %, preferably 1 wt % to 35 wt %, even more preferably 1 wt % to 6 wt % of a C₃ to C₂₀ comonomer, preferably a C₄ to C₈ comonomer, preferably hexene or octene, based upon the weight of the copolymer. Preferably these polymers are metallocene polyethylenes (mPEs).

Useful mPE homopolymers or copolymers may be produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. Several commercial products produced with such catalyst/activator combinations are commercially available from ExxonMobil Chemical Company in Houston, Tex. under the tradename EXCEED™ mPE or ENABLE™ mPE.

In a class of embodiments, the multilayer film described herein comprises a first polyethylene (as a polyethylene defined herein) in at least one of the outer layers. Preferably, the first polyethylene has a density of about 0.900 to about 0.945 g/cm³, a melt index (MI), I_{2.16}, of about 0.1 to about 15 g/10 min, a molecular weight distribution (MWD) of about 1.5 to about 5.5, and a melt index ratio (MIR), I_{21.6}/I_{2.16}, of about 10 to about 100. More preferably, the first polyethylene has a density of about 0.900 to about 0.920 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25.

In various embodiments, the first polyethylene may have one or more of the following properties:

(a) a density (sample prepared according to ASTM D-4703, and the measurement according to ASTM D-1505) of about 0.900 to 0.945 g/cm³, or about 0.910 to about 0.935 g/cm³;

(b) a Melt Index (“MI”, I_{2.16}, ASTM D-1238, 2.16 kg, 190° C.) of about 0.1 to about 15 g/10 min, or about 0.3 to about 10 g/10 min, or about 0.5 to about 5 g/10 min;

(c) a Melt Index Ratio (“MIR”, I_{21.6} (190° C., 21.6 kg)/I_{2.16} (190° C., 2.16 kg)) of about 10 to about 100, or about 10 to about 50, or about 10 to about 25;

(d) a Composition Distribution Breadth Index (“CDBI”) of up to about 85%, or up to about 75%, or about 5 to about 85%, or 10 to 75%. The CDBI may be determined using techniques for isolating individual fractions of a sample of the resin. The preferred technique is Temperature Rising Elution Fraction (“TREF”), as described in Wild, et al., J. Poly. Sci., Poly. Phys. Ed., Vol. 20, p. 441 (1982), which is incorporated herein for purposes of U.S. practice;

(e) a molecular weight distribution (“MWD”) of about 1.5 to about 5.5, and/or

(f) a branching index of about 0.9 to about 1.0, or about 0.96 to about 1.0, or about 0.97 to about 1.0. Branching Index is an indication of the amount of branching of the polymer and is defined as g′=[Rg]²_{br}/[Rg]²ₗᵢₙ. “Rg” stands for Radius of Gyration, and is measured using a Waters 150 gel permeation chromatograph equipped with a Multi-Angle Laser Light Scattering (“MALLS”) detector, a viscosity detector and a differential refractive index detector. “[Rg]_{br}” is the Radius of Gyration for the branched polymer sample and “[Rg]ₗᵢₙ” is the Radius of Gyration for a linear polymer sample. The branching index is inversely proportional to the amount of branching. Thus, lower values for g′ indicate relatively higher amounts of branching. The amounts of short and long-chain branching each contribute to the branching index according to the formula: g′=g′_{LCB}×g′_{SCB}. Thus, the branching index due to long-chain branching may be calculated from the experimentally determined value for g′ as described by Scholte, et al, in J. App. Polymer Sci., 29, pp. 3763-3782 (1984), incorporated herein by reference.

The first polyethylene is not limited by any particular method of preparation and may be formed using any process known in the art. For example, the first polyethylene may be formed using gas phase, solution, or slurry processes.

In one embodiment, the first polyethylene is formed in the presence of a metallocene catalyst. For example, the first polyethylene may be an mPE produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. mPEs useful as the first polyethylene include those commercially available from ExxonMobil Chemical Company in Houston, Tex., such as those sold under the trade designation EXCEED™.

In accordance with another preferred embodiment where the first propylene-based elastomer used in the core layer has an ethylene content of less than or equal to about 13 wt % (based on total weight of the first propylene-based elastomer), the multilayer film described herein further comprises in the core layer a second polyethylene, as a polyethylene defined herein. Typically, the second polyethylene useful in the present invention may be characterized by a branching index, g′ᵥᵢₛ, of about 0.40 to about 0.45, preferably about 0.40 to about 0.43, about 0.40 to about 0.42, or about 0.41 to about 0.42.

In various embodiments, the second polyethylene as described herein may further have one or more of the following properties:

(a) a density (sample prepared according to ASTM D-4703, and the measurement according to ASTM D-1505) of about 0.910 to 0.940 g/cm³, or about 0.912 to about 0.935 g/cm³, or about 0.915 to about 0.925 g/cm³;

(b) a Melt Index (“MI”, I_{2.16}, ASTM D1238, 2.16 kg, 190° C.) of about 0.1 to about 10 g/10 min, or about 0.3 to about 8 g/10 min, or about 0.5 to about 5 g/10 min;

(c) a molecular weight distribution (“MWD”) of about 4 to about 40, and/or

(d) a Vicat softening point (according to ASTM D1525) of about 20° C. to about 80° C., or about 30° C. to about 60° C.

In one embodiment, the second polyethylene is LDPE. The LDPEs that are useful in the core layer of the multilayer films described herein are ethylene based polymers produced by free radical initiation at high pressure in a tubular or autoclave reactor as well known in the art. The free radicals trigger the incorporation of chain lengths along the length of a main chain so forming long chain branches, usually by what is known as a back-biting mechanism. The branches vary in length and configuration. The average molecular weight can be controlled with a variety of telogens or transfer agents which may incorporate at the chain ends or along the chain. Comonomers may be used such as olefins other than ethylene or minor amounts of olefinically copolymerizable monomers containing polar moieties such a carbonyl group. Particularly suitable LDPEs used as the second polyethylene described herein are ethylene homopolymers, which are available from ExxonMobil Chemical Company under the tradename ExxonMobil™ LDPE.

In another preferred embodiment where two inner layers each between the core layer and each outer layer is present, the multilayer film described herein comprises a third polyethylene, as a polyethylene defined herein, in at least one of the inner layer. Preferably, the third polyethylene has a density of about 0.900 to about 0.945 g/cm³, a melt index (MI), I_{2.16}, of about 0.1 to about 15 g/10 min, a molecular weight distribution (MWD) of about 1.5 to about 5.5, and a melt index ratio (MIR), I_{21.6}/I_{2.16}, of about 10 to about 100. More preferably, the third polyethylene has a density of about 0.900 to about 0.915 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25. In various embodiments, the third polyethylene may have one or more of the properties or be prepared as defined above for the first polyethylene. The third polyethylene may be the same as or different from the first polyethylene. Preferably, the third polyethylenes is different from the first polyethylene in a lower density. Preferably, the third polyethylene has a density no higher than about 0.912 g/cm³.

The third polyethylene is not limited by any particular method of preparation and may be formed using any process known in the art. In one embodiment, the third polyethylene is formed in the presence of a metallocene catalyst. mPEs useful as the third polyethylene include those commercially available from ExxonMobil Chemical Company in Houston, Tex., such as those sold under the trade designation EXCEED™.

The first polyethylene present in at least one of the outer layers, the second polyethylene optionally present in the core layer, and the third polyethylene optionally present in at least one of the inner layers of the multilayer film described herein may be optionally in a blend with one or more other polymers, such as polyethylenes defined herein, which blend is referred to as polyethylene composition. In particular, the polyethylene compositions described herein may be physical blends or in situ blends of more than one type of polyethylene or compositions of polyethylenes with polymers other than polyethylenes where the polyethylene component is the majority component, e.g., greater than 50 wt % of the total weight of the composition. Preferably, the polyethylene composition is a blend of two polyethylenes with different densities.

### Additives

The multilayer film described herein may also contain in at least one layer various additives as generally known in the art. Examples of such additives include a slip agent, an antiblock, a filler, an antioxidant, an ultraviolet light stabilizer, a thermal stabilizer, a pigment, a processing aid, a crosslinking catalyst, a flame retardant, and a foaming agent, etc. Preferably, the additives may each individually present in an amount of about 0.01 wt % to about 50 wt %, or about 0.1 wt % to about 10 wt %, or from 1 wt % to 5 wt %, based on total weight of the film layer.

In a preferred embodiment, at least one of a slip agent and an antiblock is employed in any or each of the two outer layer and the core layer of the multilayer film described herein to control the coefficient of friction to ensure slippery surface exposed to the bubble interior and deliver desired winding and unwinding properties during blown extrusion. Additives may also impact sealing property of the formed film.

Any additive useful for the multilayer film may be provided separately or together with other additive(s) of the same or a different type in a pre-blended masterbatch, where the target concentration of the additive is reached by combining each neat additive component in an appropriate amount to make the final composition.

### Layer Composition

In one embodiment of the present invention, the multilayer film described herein may be comprised of at least one of the outer layers the first polyethylene described herein. Preferably, the first polyethylene is present in an amount of at least about 80 wt %, for example, anywhere between 80 wt %, 85 wt %, 90 wt %, or 95 wt %, and 100 wt %, based on total weight of polymer in the outer layer.

In another embodiment of the present invention, the multilayer film described herein may be comprised of the first propylene-based elastomer described herein in an amount of at least 50 wt %, for example, anywhere between 50 wt %, 55 wt %, 60 wt %, 65 wt %, 70 wt %, or 75 wt %, and 80 wt %, 85 wt %, 90 wt %, 95 wt %, or 100 wt %, based on total weight of polymer in the core layer. Preferably, the amount of the first propylene-based elastomer in the core layer composition of the multilayer film is selected based on its ethylene content level.

In one preferred embodiment where the ethylene-derived units in the first propylene-based elastomer are present in an amount of at least about 13 wt %, for example, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, or in the range of any combinations of the values recited herein, the core layer comprises 100 wt % of the first propylene-based elastomer, based on total weight of polymer in the core layer.

In another preferred embodiment where the ethylene-derived units in the first propylene-based elastomer are present in an amount of less than or equal to about 13 wt %, for example, about 3 wt %, about 4 wt %, about 5 wt %, about 6 wt %, about 7 wt %, about 8 wt %, about 9 wt %, about 10 wt %, about 11 wt %, about 12 wt %, about 13 wt %, or in the range of any combinations of the values recited herein, the core layer further comprises at least about 10 wt % of the second polyethylene described herein, in addition to presence of about 50 wt % to about 90 wt %, for example, anywhere between 50 wt %, 55 wt %, 60 wt %, 65 wt %, or 70 wt %, and 75 wt %, 80 wt %, 85 wt %, or 90 wt %, of the first propylene-based elastomer, based on total weight of polymer in the core layer.

Correspondingly, the second polyethylene described herein is preferably present when the first propylene-based elastomer has an ethylene content of no more than about 13 wt %, in an amount of at least about 10 wt %, for example, about 10 wt %, about 15 wt %, about 20 wt %, about 25 wt %, about 30 wt %, about 35 wt %, about 40 wt %, about 45 wt %, about 50 wt %, or in the range of any combinations of the values recited herein, based on total weight of polymer in the core layer.

In a preferred embodiment, the multilayer film described herein may comprise the second propylene-based elastomer described herein in at least one of the inner layers. Preferably, inner layer composition of the multilayer film described herein may likewise depend on ethylene content level of the second propylene-based elastomer in view of a threshold value of 13 wt %, based on total weight of the second propylene-based elastomer. In one preferred embodiment where the ethylene-derived units in the second propylene-based elastomer are present in an amount of at least about 13 wt %, for example, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, or in the range of any combinations of the values recited herein, the second propylene-based elastomer is present in an amount of at least about 50 wt %, for example, anywhere between 50 wt %, 55 wt %, 60 wt %, 65 wt %, 70 wt %, or 75 wt %, and 80 wt %, 85 wt %, 90 wt %, 95 wt %, or 100 wt %, based on total weight of polymer in the inner layer. In another preferred embodiment where the ethylene-derived units in the second propylene-based elastomer are present in an amount of less than or equal to about 13 wt %, for example, about 3 wt %, about 4 wt %, about 5 wt %, about 6 wt %, about 7 wt %, about 8 wt %, about 9 wt %, about 10 wt %, about 11 wt %, about 12 wt %, about 13 wt %, or in the range of any combinations of the values recited herein, the second propylene-based elastomer is present in an amount of about 20 wt % to about 50 wt %, for example, anywhere between 20 wt %, 25 wt %, or 30 wt %, and 35 wt %, 40 wt %, 45 wt %, or 50 wt %, based on total weight of polymer in the inner layer.

In another preferred embodiment, the multilayer film described herein may comprise the third polyethylene described herein in at least one of the inner layers. Optionally bounded by ethylene content level of the second propylene-based elastomer described herein, the third polyethylene may be present in amount of no more than about 50 wt %, no more than about 40 wt %, no more than about 30 wt %, no more than about 20 wt %, or no more than about 10 wt %, in case of an ethylene content of the second propylene-based elastomer equal to or above the 13 wt % (based on total weight of the second propylene-based elastomer) threshold, while may be otherwise present in amount of about 50 wt % to about 80 wt %, for example, about 50 wt %, about 55 wt %, about 60 wt %, about 65 wt %, about 70 wt %, about 75 wt %, about 80 wt %, or in the range of any combinations of the values recited herein, based on total weight of polymer in the inner layer.

Additional polymers other than those described above may also be introduced into the multilayer film described herein, including but not limited to the propylene-based elastomers and the polyethylenes as defined herein.

Propylene-based elastomers and polyethylenes employed in the multilayer film all assume respective roles in the multilayer film by presence in specific layers in specific amounts to contribute to enhanced property profile targeted by stretch hood applications. Typically, the first propylene-based elastomer in the core layer can provide high elasticity and toughness, which the conventional film using EVA is short of, and, when blended with the second polyethylene, can even overcome defects in bubble stability and processability during blown extrusion, while the first polyethylene in at least one of the outer layers is mainly responsible for sealing and optical properties and further strengthens toughness. When the two inner layers between the core layer and each outer layer are present as the tie layer between the polyethylene-containing outer layers and the propylene-based elastomer-containing core layer, the second propylene-based elastomer, optionally accompanied by the third polyethylene, can serve the purpose of maintaining holding force and increasing stretchability. By conforming to the structure-wise compositions set out herein, these components can coordinate with each other to lead to well-balanced overall performance superior to that achievable with the conventional film solutions.

### Film Structures

The multilayer film of the present invention may further comprise additional layer(s), which may be any layer typically included in multilayer film constructions. For example, the additional layer(s) may be made from:

1. Polyolefins. Preferred polyolefins include homopolymers or copolymers of C₂ to C₄₀ olefins, preferably C₂ to C₂₀ olefins, preferably a copolymer of an α-olefin and another olefin or α-olefin (ethylene is defined to be an α-olefin for purposes of this invention). Preferably homopolyethylene, homopolypropylene, propylene copolymerized with ethylene and/or butene, ethylene copolymerized with one or more of propylene, butene or hexene, and optional dienes. Preferred examples include thermoplastic polymers such as ultra-low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and compositions of thermoplastic polymers and elastomers, such as, for example, thermoplastic elastomers and rubber toughened plastics.

2. Polar polymers. Preferred polar polymers include homopolymers and copolymers of esters, amides, acetates, anhydrides, copolymers of a C₂ to C₂₀ olefin, such as ethylene and/or propylene and/or butene with one or more polar monomers, such as acetates, anhydrides, esters, alcohol, and/or acrylics. Preferred examples include polyesters, polyamides, ethylene vinyl acetate copolymers, and polyvinyl chloride.

3. Cationic polymers. Preferred cationic polymers include polymers or copolymers of geminally disubstituted olefins, α-heteroatom olefins and/or styrenic monomers. Preferred geminally disubstituted olefins include isobutylene, isopentene, isoheptene, isohexane, isooctene, isodecene, and isododecene. Preferred α-heteroatom olefins include vinyl ether and vinyl carbazole, preferred styrenic monomers include styrene, alkyl styrene, para-alkyl styrene, α-methyl styrene, chloro-styrene, and bromo-para-methyl styrene. Preferred examples of cationic polymers include butyl rubber, isobutylene copolymerized with para methyl styrene, polystyrene, and poly-α-methyl styrene.

4. Miscellaneous. Other preferred layers can be paper, wood, cardboard, metal, metal foils (such as aluminum foil and tin foil), metallized surfaces, glass (including silicon oxide (SiOₓ) coatings applied by evaporating silicon oxide onto a film surface), fabric, spunbond fibers, and non-wovens (particularly polypropylene spunbond fibers or non-wovens), and substrates coated with inks, dyes, pigments, and the like.

In particular, a multilayer film can also include layers comprising materials such as ethylene vinyl alcohol (EVOH), polyamide (PA), polyvinylidene chloride (PVDC), or aluminum, so as to obtain barrier performance for the film where appropriate.

In one aspect of the invention, the multilayer film described herein may be produced in a stiff oriented form (often referred to as “pre-stretched” by persons skilled in the art) and may be useful for laminating to inelastic materials, such as polyethylene films, biaxially oriented polyester (e.g., polyethylene terephthalate (PET)) films, biaxially oriented polypropylene (BOPP) films, biaxially oriented polyamide (nylon) films, foil, paper, board, or fabric substrates, or may further comprise one of the above substrate films to form a laminate structure.

The thickness of the multilayer films may range from about 10 to about 200 μm in general and is mainly determined by the intended use and properties of the film. Stretch films may be thin; those for shrink films or heavy duty bags are much thicker. Conveniently, the multilayer film described herein has a thickness of from about 10 to about 200 from about 20 to about 150 or from about 30 to about 130 Desirably, a film thickness not exceeding 60 preferably from about 30 to about 50 may be well suited to hand stretch hood films, while one varying within a range between higher end values, preferably from about 50 to about 130 can be acceptable for machine stretch hood films. In a preferred embodiment, the core layer has a thickness of at least about one third, for example, about one third, about two fifths, about half, about three fifths, about two thirds, about four fifths, or in the range of any combination of the values recited herein, of total thickness of the multilayer film. In another preferred embodiment, the thickness ratio between one of the outer layers and the core layer is about 1:1 to about 1:4, for example, about 1:1, about 1:1.5, about 1:2, about 1:2.5, about 1:3, about 1:3.5, or about 1:4. In yet another embodiment where the inner layers described herein are present, the thickness ratio between one of the outer layers, one of the inner layers, and the core layer can be, for example, about 1:1:2:1:1, about 1:1:3:1:1, about 1:2:3:2:1, about 1:2:4:2:1, or vary in the range of any combination of the values recited herein.

The multilayer film described herein may have an A/Y/A structure wherein A is an outer layer and Y is the core layer in contact with the outer layer. Suitably, one or both outer layers are a skin layer forming one or both film surfaces and can serve as a lamination skin (the surface to be adhered to a substrate film) or a sealable skin (the surface to form a seal). The composition of the A layers may be the same or different, but conform to the limitations set out herein. Preferably, the A layers are identical. The multilayer film may have an A/B/X/B/A structure wherein A are outer layers and X represents the core layer and B are inner layers between the core layer and each outer layer. The composition of the A layers may be the same or different, but conform to the limitations set out herein. Preferably, the two A layers are identical. The composition of the B layers may also be the same or different, but conform to the limitations set out herein. Preferably, the two B layers are identical. Preferably, the multilayer has a density of about 0.88 to about 0.92 g/cm³.

In one preferred embodiment where the propylene-based elastomer in the core layer has an ethylene content of 13 wt % or more (based on total weight of the first propylene-based elastomer), the multilayer film may have an A/Y/A structure, comprising: (a) two outer layers, each comprising 100 wt % of a blend of two polyethylenes, based on total weight of polymer in each outer layer, wherein each of the polyethylenes has a density of about 0.900 to about 0.920 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25; and (b) a core layer between the two outer layers, the core layer comprising from about 100 wt % of a propylene-based elastomer, based on total weight of polymer in the core layer, wherein the propylene-based elastomer has at least about 60 wt % propylene-derived units and about 13 to about 25 wt % ethylene-derived units, based on total weight of the propylene-based elastomer, and a heat of fusion of less than about 80 J/g, wherein the multilayer film has at least one of the following properties: (i) an elastic recovery of at least about 71%; (ii) a maximum force at 100% strain of less than or equal to about 0.2 N/μm; and (iii) a tear resistance of at least about 12 g/μm in MD. Preferably, the thickness ratio between each of the outer layers and the core layer is about 1:3. Preferably, the multilayer film has a thickness of from about 30 to about 50 μm.

In another preferred embodiment, the multilayer film above may further comprise two inner layers each between the core layer and each outer layer to form an A/B/X/B/A structure, wherein each of the inner layer comprises (i) at least about 50 wt % of the propylene-based elastomer in the core layer, and (ii) a polyethylene having a density of about 0.900 to about 0.915 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25, based on total weight of polymer in each inner layer.

In yet another preferred embodiment where the propylene-based elastomer in the core layer has an ethylene content of no more than 13 wt % (based on total weight of the first propylene-based elastomer), the multilayer film may have an A/B/X/B/A structure, comprising: (a) two outer layers, each comprising 100 wt % of a blend of two polyethylenes, based on total weight of polymer in each outer layer, wherein each of the polyethylenes has a density of about 0.900 to about 0.920 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25; (b) a core layer between the two outer layers, the core layer comprising at least about 50 wt % of a propylene-based elastomer and at least about 10 wt % of a polyethylene, based on total weight of polymer in the core layer, wherein the propylene-based elastomer has at least about 60 wt % propylene-derived units and about 3 to about 13 wt % ethylene-derived units, based on total weight of the propylene-based elastomer, and a heat of fusion of less than about 80 J/g, wherein the polyethylene has a g′ᵥᵢₛ of about 0.40 to about 0.45; and (c) two inner layers each between the core layer and each outer layer, each of the inner layer comprising (i) about 20 wt % to about 50 wt % of the propylene-based elastomer in the core layer, and (ii) a polyethylene having a density of about 0.900 to about 0.915 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25, based on total weight of polymer in each inner layer, wherein the multilayer film has at least one of the following properties: (i) a tensile at break of at least about 40 MPa in MD and of at least about 38 MPa in TD; (ii) a tear propagation of less than or equal to about 10%; (iii) an elastic recovery of at least about 55%; and (iv) a holding force (normalized to 100 μm end) of at least about 22 N/μm. Preferably, the thickness ratio between each of the outer layers, each of the inner layers, and the core layer is about 1:1:2. Preferably, the multilayer film having a thickness of from about 50 to about 130 μm.

It has been discovered that, by virtue of flexibility in choice of propylene-based elastomers with a given ethylene content level, the inventive film design can not only achieve overall performance well qualified for stretch hood applications but also highlight certain properties as specifically needed to satisfy different stretch hood packaging processes and end uses. Particularly, starting with propylene-based elastomers having different ethylene content levels relative to a threshold of 13 wt % (based on total weight of the propylene-based elastomer), “soft” stretchability especially suited to hand stretch hood films can be expected by, for example, preparing the multilayer film described herein with outer layers made of mPE and core layer made of a neat propylene-based elastomer having an ethylene content of at least 13 wt %, while increased elasticity and improved bubble stability, together with sufficient holding force, can be simultaneously established by, for example, preparing the multilayer film described herein with core layer made of a blend of LDPE and at least 50% (based on total weight of polymer in the core layer) of a propylene-based elastomer having an ethylene content of less than or equal to 13 wt % and inner layers comprising no more than 50 wt % of the same propylene-based elastomer. Tailored design in two directions greatly expands potential for improvement on property profile of the multilayer film used for stretch hood applications. Therefore, the present invention can serve as a promising alternative to the current film solutions especially for more demanding applications where until now their performance had not been satisfactory.

### Film Properties and Applications

Films described herein can be used for any purpose, but are particularly suited to stretch hood applications. The multilayer film described herein and stretch hood films comprising it can display outstanding properties as demonstrated by tensile strength, resistance to puncture and tearing, elastic recovery, transparency, which is especially important for stretch hood applications. The multilayer film described herein can be used to establish a sufficient holding force and also to optimize the film behavior during extension and after contraction around a load on a stretch hood packaging line with reduced risk of tearing or puncturing. In production of blown extrusion, good bubble stability can be achieved and the resulting film can have a high transparency due to the low amount of particulate antiblock needed. Additionally, the multilayer films described herein can allow the stretch hood to have increased “softness”, wherein the film has sufficient holding force to surround and stabilize the goods but not too much holding force where the goods are damaged. Furthermore, due to optimized balance of elasticity and holding force provided by the multilayer film described herein, the films can be used as stretch hoods for pallets of more than one size.

The multilayer film has at least one of the following properties: (i) a tensile at break of at least about 40 MPa in the Machine Direction (MD) and of at least about 38 MPa in the Transverse Direction (TD); (ii) a tear propagation of less than or equal to about 10%; (iii) an elastic recovery of at least about 55%; (iv) a holding force (normalized to 100 μm end) of at least about 22 N/μm; (v) a maximum force at 100% strain of less than or equal to about 0.2 N/μm; and (vi) a tear resistance of at least about 12 g/μm in MD.

### Methods for Making the Multilayer Film and Stretch Hood Packaging Process

Also provided are methods for making multilayer films of the present invention.

A method for making a multilayer film may comprise the steps of: (a) preparing two outer layers, wherein at least one of the outer layers comprises a first polyethylene; (b) preparing a core layer between the two outer layers, comprising a first propylene-based elastomer having at least about 60 wt % propylene-derived units and about 3 to about 25 wt % ethylene-derived units, based on total weight of the first propylene-based elastomer, and a heat of fusion of less than about 80 J/g, wherein the first propylene-based elastomer is present in an amount of at least 50 wt %, based on total weight of polymer in the core layer; and (c) forming a film comprising the layers in steps (a) and (b), wherein the multilayer film has at least one of the following properties: (i) a tensile at break of at least about 40 MPa in the Machine Direction (MD) and of at least about 38 MPa in the Transverse Direction (TD); (ii) a tear propagation of less than or equal to about 10%; (iii) an elastic recovery of at least about 55%; (iv) a holding force (normalized to 100 μm end) of at least about 22 N/μm; (v) a maximum force at 100% strain of less than or equal to about 0.2 N/μm; and (vi) a tear resistance of at least about 12 g/μm in MD. Preferably, the method described herein may further comprise a step between step (b) and step (c) of preparing two inner layers each between the core layer and each outer layer, wherein at least one of the inner layer comprises a second propylene-based elastomer having at least about 60 wt % propylene-derived units and about 3 to about 25 wt % ethylene-derived units, based on total weight of the second propylene-based elastomer, and a heat of fusion of less than about 80 J/g.

The multilayer films described herein may be formed by any of the conventional techniques known in the art including blown extrusion, cast extrusion, coextrusion, blow molding, casting, and extrusion blow molding.

In one embodiment of the present invention, the multilayer films of the present invention are formed by using blown techniques, i.e., to form a blown film. For example, the composition described herein can be extruded in a molten state through an annular die and then blown and cooled to form a tubular, blown film, which can then be axially slit and unfolded to form a flat film. As a specific example, blown films can be prepared as follows. The polymer composition is introduced into the feed hopper of an extruder, such as a 50 mm extruder that is water-cooled, resistance heated, and has an L/D ratio of 30:1. The film can be produced using a 28 cm W&H die with a 1.4 mm die gap, along with a W&H dual air ring and internal bubble cooling. The film is extruded through the die into a film cooled by blowing air onto the surface of the film. The film is drawn from the die typically forming a cylindrical film that is cooled, collapsed and, optionally, subjected to a desired auxiliary process, such as slitting, treating, sealing, or printing. Typical melt temperatures are from about 180° C. to about 230° C. Blown film rates are generally from about 3 to about 25 kilograms per hour per inch (about 4.35 to about 26.11 kilograms per hour per centimeter) of die circumference. The finished film can be wound into rolls for later processing. An illustrative blown film process and apparatus suitable for forming films according to embodiments of the present invention is described in U.S. Pat. No. 5,569,693.

The compositions prepared as described herein are also suited for the manufacture of blown film in a high-stalk extrusion process. In this process, a polyethylene melt is fed through a gap (typically 0.5 to 1.6 mm) in an annular die attached to an extruder and forms a tube of molten polymer which is moved vertically upward. The initial diameter of the molten tube is approximately the same as that of the annular die. Pressurized air is fed to the interior of the tube to maintain a constant air volume inside the bubble. This air pressure results in a rapid 3-to-9-fold increase of the tube diameter which occurs at a height of approximately 5 to 10 times the die diameter above the exit point of the tube from the die. The increase in the tube diameter is accompanied by a reduction of its wall thickness to a final value ranging from approximately 10 to 50 μm and by a development of biaxial orientation in the melt. The expanded molten tube is rapidly cooled (which induces crystallization of the polymer), collapsed between a pair of nip rolls and wound onto a film roll.

In blown film extrusion, the film may be pulled upwards by, for example, pinch rollers after exiting from the die and is simultaneously inflated and stretched transversely sideways to an extent that can be quantified by the blow up ratio (BUR). The inflation provides the transverse direction (TD) stretch, while the upwards pull by the pinch rollers provides a machine direction (MD) stretch. As the polymer cools after exiting the die and inflation, it crystallizes and a point is reached where crystallization in the film is sufficient to prevent further MD or TD orientation. The location at which further MD or TD orientation stops is generally referred to as the “frost line” because of the development of haze at that location.

Preferably, the multilayer film described herein is made by blown film extrusion in tubular form adapted to form a stretch hood upon stretching in MD and TD. Stretch hood packaging process using the multilayer film described herein, i.e. the application of a film tube to package the object or collection of objects on a stretch hood packaging machine involves the steps described by way of example in EP0461667, where the top of the stretch hood is sealed.

In a first step (see FIGS. 1 and 2 of EP0461667) a flattened film tube is unrolled and opened up to fit around a stretcher, which may be in the form of a frame as shown or in the form of four corner devices as illustrated in FIG. 6. At this stage the top of the tube can be heat sealed before it is cut-off, creating an inverted bag. The stretcher device can enter the inverted bag from below. The film material is gathered around the stretcher by take down rollers at each corner (not shown in the Figures). The film is gripped in a nip between the stretcher and the rollers. The takedown rollers cause the film to be folded transversely and gathered on the stretcher. The film and rollers have to have enough friction for an efficient gathering and take down operation. The heat sealing at the top end of the tube requires high hot tack and seal strength to survive subsequent stretching. The gathered, transversely folded tube is then expanded by the stretcher in the transverse film direction beyond the external dimensions of the palletized load. This requires a pre-determined elasticity that permits stretching and a reversion of the stretch later upon relaxation (see FIG. 3 of EP0461667). The expanded stretcher with the transversely stretched film tube is then passed downwards over the palletized load unfolding and releasing the film (see FIG. 4 of EP0461667). This requires that the film tube, in its tensioned condition, has a moderate coefficient of friction with the stretcher to allow it to be released easily from the stretcher while at the same time submitting the film to a sufficient force in the machine direction to achieve a moderate degree of machine direction stretch. The stretcher remains in the expanded state after releasing the lower edge of the film hood and returns upwards to the starting positions past the hood, sealed at the top, now contracted around the palletized load.

More information on the use of films in stretch hood packaging machines can be found in WO 2005/042346; WO 2006/076917; U.S. Pat. Nos. 6,470,654; 7,320,403; and 7,234,389, all of which are incorporated herein by reference.

In some embodiments, the stretch hood is sealed at one end to protect and cover the top of the palletized load. Alternatively in other embodiments where protection is a lower priority, the stretch hood may be open at the top.

In the course of applying the stretch hood to a palletized load, the film may undergo major levels of stretching (well over 50%) on the stretching device of the stretch hood packaging machine. The resistance to stretching by friction against a gripper surface of the stretch hood packaging machine should be minimized, particularly when thin films are used which become even thinner in the course of stretching.

In addition to machine stretch hood packaging process, the multilayer film described herein can also be tailored to allow manual hood operation where an operator can easily stretch the film tube to a certain extent, e.g. of 10% to 20%, and hood the film onto objects.

### EXAMPLES

The present invention, while not meant to be limited by, may be better understood by reference to the following example and tables.

### Example 1

Example 1 illustrates mechanical performance demonstrated by an inventive sample of three layers (Sample 1) using a propylene-based elastomer with an ethylene content of more than 13 wt % (based on total weight of the propylene-based elastomer) in comparison with a comparative sample (Sample la) differing from the inventive sample in total thickness and use of EVA instead of the propylene-based elastomer but otherwise identical in terms of layer composition and film structure. Polymer and additive products used in the samples include: VISTAMAXX™ 6102FL performance polymer (ExxonMobil Chemical Company, Houston, Tex., USA) (ethylene content: 16 wt %, density: 0.862 g/cm³, MFR: 3 g/10 min), NEXXSTAR™ low EVA-00111 LDPE resin (MI: 0.50 g/10 min, vinyl acetate content: 7.5 wt %) (ExxonMobil Chemical Company, Houston, Tex., USA), EXCEED™ 1018HA mPE resin (density: 0.918 g/cm³, MI: 1.0 g/10 min) (ExxonMobil Chemical Company, Houston, Tex., USA), EXCEED™ 1018LA mPE resin (density: 0.918 g/cm³, MI: 1.0 g/10 min) (ExxonMobil Chemical Company, Houston, Tex., USA), and the POLYBATCH™ CE 505E slip agent (A. Schulman, Fairlawn, Ohio, USA). Sample 1 was prepared on a three-layer coextrusion blown film line with a blow up ratio (BUR) of 3.0 with an A/Y/A′ structure of 50 μm. Sample la is a commercially available machine stretch hood film with an A/Y/A′ structure of 86 μm. A refers to the outer layer exposed to the bubble exterior while A′ refers to the outer layer exposed to the bubble interior during bubble blowing process in blown extrusion, and Y is the core layer in contact with the outer layers. Slip agent was added in the A′ layer to ensure slippery surface exposed to the bubble interior and deliver desired winding and unwinding properties during blown extrusion. Both samples have a layer thickness ratio of 1:3:1. Samples were conditioned at 23° C.±2° C. and 50%±10% relative humidity for at least 40 hours prior to determination of all properties. Structure-wise formulations of the film samples, accompanied by test results thereof, are depicted in Table 1.

The stretch hood tear propagation test was based on ASTM 882 but modified in that a film sample (50*50 mm) with a small pre-cut (2 mm wide in MD) was stretched in TD to 100% elongation at 1000 mm/min cross head speed. To pass the test, the film should not tear uncontrolled but show an intermittent tear propagation behavior. The Fₘₐₓ was where the tearing was arrested and further force application was required to restart it. Tear propagation test is used to evaluate the potential of stretch failure when pin hole is formed in a film. The lower the tear propagation is, the better tear propagation properties.

Elmendorf tear strength was measured based on ASTM D1922-06a using the Tear Tester 83-11-01 from TMI Group of Companies and measures the energy required to continue a pre-cut tear in the test sample, presented as tearing force in gram. Samples were cut across the web using the constant radius tear die and were free of any visible defects (e.g., die lines, gels, etc.).

The holding force and elastic recovery of the stretch hood film were determined by a method based on an ASTM D5459 standard test method for elastic recovery, permanent deformation, and stress retention of stretch film but modified in that the film sample was stretched to a certain elongation (100%) at a certain cross-head speed (1000 mm/min). When the 100% elongation was reached, the cross-head was kept in this position for 5 seconds and then reversed to a certain 85% elongation. The load on the sample was then measured after a 60 second waiting time in (N/50 mm) and recorded as the holding force. This mimics the holding force acting on the palletized load. Subsequently the cross-head was returned to a position where the force read zero. The elongation was recorded as the elastic recovery. The normalized holding force was calculated by adjusting the holding force according to the thickness of the film to a thickness of 100 μm N/50 mm

TABLE 1
STRUCTURE-WISE FORMULATIONS (WT %)
AND MECHANICAL PROPERTIES FOR FILM
SAMPLES OF EXAMPLE 1

| | Sample No. | |
|---|---|---|
| | 1 | 1a |
| A | EXCEED ™ 1018HA | EXCEED ™ 1018HA |
| | (40) | (40) |
| | EXCEED ™ 1018LA | EXCEED ™ 1018LA |
| | (60) | (60) |
| Y | VISTAMAXX ™ | NEXXSTAR ™ low |
| | 6102FL (98) | EVA-00111 |
| | POLYBATCH ™ CE | POLYBATCH ™ CE |
| | 505E (2) | 505E (2) |
| A′ | EXCEED ™ 1018HA | EXCEED ™ 1018HA |
| | (38) | (38) |
| | EXCEED ™ 1018LA | EXCEED ™ 1018LA |
| | (60) | (60) |
| | POLYBATCH ™ CE | POLYBATCH ™ CE |
| | 505E (2) | 505E (2) |
| Fₘₐₓ at 100% strain | 0.16 | 0.44 |
| (N/μm) | | |
| Elmendorf tear MD | 14.7 | 10.8 |
| (g/μm) | | |
| Elastic recovery (%) | 71.64 | 70.34 |

As shown by test results in Table 1, the inventive Sample 1 outperformed the comparative machine stretch hood film Sample la in terms of properties, including a much lower maximum force at 100% strain, a higher tear resistance in MD, and increased elastic recovery, indicating advantages in manual operation ease, sufficient tear resistance in MD to balance emphasized force exerted in MD during manual hooding operation, and improved film behavior during extension and after contraction around a load on a stretch hood packaging line with reduced risk of tearing or puncturing over the conventional machine stretch hood.

### Example 2

Example 2 demonstrates the effect of using a propylene-based elastomer with an ethylene content of less than 13 wt % (based on total weight of the propylene-based elastomer) on mechanical performance demonstrated by an inventive sample of five layers (Sample 2) in comparison with two comparative samples (Samples 2a and 2b) of three layers comprising EVA in the core layer. Polymer and additive products used in the samples include: VISTAMAXX™ 3020FL performance polymer (ExxonMobil Chemical Company, Houston, Tex., USA) (ethylene content: 11 wt %, density: 0.874 g/cm³, MFR: 3 g/10 min), NEXXSTAR™ low EVA-00111 LDPE resin (MI: 0.50 g/10 min, vinyl acetate content: 7.5 wt %) (ExxonMobil Chemical Company, Houston, Tex., USA), EXCEED™ 1018HA mPE resin (density: 0.918 g/cm³, MI: 1.0 g/10 min) (ExxonMobil Chemical Company, Houston, Tex., USA), EXCEED™ 1018LA mPE resin (density: 0.918 g/cm³, MI: 1.0 g/10 min) (ExxonMobil Chemical Company, Houston, Tex., USA), EXCEED™ 1012HA mVLDPE mPE resin (density: 0.912 g/cm³, MI: 1.0 g/10 min) (ExxonMobil Chemical Company, Houston, Tex., USA), EXXONMOBIL™ LDPE LD 150AC LDPE resin (density: 0.923 g/cm³, MI: 0.75 g/10 min) (ExxonMobil Chemical Company, Houston, Tex., USA), LDPE 2420D (density: 0.922-0.923 g/cm3, MI: ˜0.3 g/10 min) (PetroChina Daqing Petrochemical Company (CNPC-DQ)), and the POLYBATCH™ F15 antiblock agent (A. Schulman, Fairlawn, Ohio, USA). Sample 2 was prepared on a five-layer coextrusion blown film line with a BUR of 3.2 with an A/B/X/B/A structure of 70 μm at a layer thickness ratio of 1:1:2:1:1, wherein A are outer layers and X represents the core layer and B are inner layers between the core layer and each outer layer. Sample 2a and 2b were prepared on a coextrusion blown film line, commercially available from Windmoeller & Hoelscher Corp., with a BUR of 2.7 with an A/Y/A structure of 83 μm and 96 μm, respectively, at a layer thickness ratio of 1:1:1, wherein A are outer layers and Y is the core layer in contact with the outer layers. Samples were conditioned at 23° C.±2° C. and 50%±10% relative humidity for at least 40 hours prior to determination of all properties. Structure-wise formulations of the film samples, accompanied by test results thereof, are depicted in Table 2.

Tensile properties of the films were measured by a method which is based on ASTM D882 with static weighing and a constant rate of grip separation using a Zwick 1445 tensile tester with a 200N. Since rectangular shaped test samples were used, no additional extensometer was used to measure extension. The nominal width of the tested film sample is 15 mm and the initial distance between the grips is 50 mm Tensile strength at break is defined as the tensile stress at break point during the extension test, expressed in load per unit area (MPa).

Tear propagation, elastic recovery and holding force were respectively measured for all samples by methods as previously described herein.

TABLE 2
STRUCTURE-WISE FORMULATIONS (WT %) AND MECHANICAL
PROPERTIES FOR FILM SAMPLES OF EXAMPLE 2

| | Sample No. | | |
|---|---|---|---|
| | 2 | 2a | 2b |
| A | EXCEED ™ 1018HA | EXCEED ™ 1018HA | EXCEED ™ 1018HA |
| | (38) | (38) | (38) |
| | EXCEED ™ 1018LA | EXCEED ™ 1018LA (60) | EXCEED ™ 1018LA |
| | (60) | POLYBATCH ™ F15 (2) | (60) |
| | POLYBATCH ™ F15 (2) | | POLYBATCH ™ F15 |
| | | | (2) |
| B | VISTAMAXX ™ | — | — |
| | 3020FL (40) | | |
| | EXCEED ™ 1012HA | | |
| | (60) | | |
| X/Y | VISTAMAXX ™ | VISTAMAXX ™ 3020FL | VISTAMAXX ™ |
| | 3020FL (60) | (40) | 3020FL (30) |
| | EXXONMOBIL ™ | NEXXSTAR ™ low | NEXXSTAR ™ low |
| | LDPE LD 150AC (40) | EVA-00111 (60) | EVA-00111 (70) |
| Tensile at break | 42.2 | 39.3 | 39.7 |
| MD (MPa) | | | |
| Tensile at break | 39.4 | 37.0 | 39.5 |
| TD (MPa) | | | |
| Tear | 9.4 | 12.6 | 13.1 |
| propagation (%) | | | |
| Elastic recovery | 56.2 | 54.4 | 53.7 |
| (%) | | | |
| Holding force | 22.71 | 22.90 | 21.80 |
| (normalized to | | | |
| 100 μm end) | | | |
| (N/μm) | | | |

It can be seen from Table 2 that the inventive film, featuring a core layer rich in propylene-based elastomer (more than 50 wt %, based on total weight of polymer in the core layer) and inner layers serving as tie layer between the propylene-based elastomer-containing core layer and polyethylene-containing outer layers, can enhance elasticity and tensile strength and reduced tear propagation without significantly compromising holding force, demonstrating a better-balanced overall performance than that achievable with the conventional EVA containing three-layer film.

### Example 3

Example 3 illustrates mechanical performance demonstrated by an inventive sample of three layers (Sample 3) using a propylene-based elastomer with an ethylene content of more than 13 wt % (based on total weight of the propylene-based elastomer) in comparison with a comparative sample (Sample 1a) differing from the inventive sample in total thickness and use of EVA instead of the propylene-based elastomer but otherwise identical in terms of layer composition and film structure. Polymer and additive products used in the samples include: VISTAMAXX™ 3020FL performance polymer (ExxonMobil Chemical Company, Houston, Tex., USA) (ethylene content: 11 wt %, density: 0.874 g/cm3, MFR: 3 g/10 min), NEXXSTAR™ low EVA-00111 LDPE resin (MI: 0.50 g/10 min, vinyl acetate content: 7.5 wt %) (ExxonMobil Chemical Company, Houston, Tex., USA), EXCEED™ 1018HA mPE resin (density: 0.918 g/cm3, MI: 1.0 g/10 min) (ExxonMobil Chemical Company, Houston, Tex., USA), EXCEED™ 1018LA mPE resin (density: 0.918 g/cm3, MI: 1.0 g/10 min) (ExxonMobil Chemical Company, Houston, Tex., USA), POLYBATCH™ F15 antiblock agent (A. Schulman, Fairlawn, Ohio, USA), and the POLYBATCH™ CE 505E slip agent (A. Schulman, Fairlawn, Ohio, USA). Sample 3 was prepared on a five-layer coextrusion blown film line with an A/Y/Y/Y/A structure of 80 μm at a layer thickness ratio of 1:2:4:2:1, wherein A are outer layers and Y are inner layers between the outer layers. Sample 3a is a commercially available machine stretch hood film with an A/Y/A′ structure of 86 μm. A refers to the outer layer exposed to the bubble exterior while A′ refers to the outer layer exposed to the bubble interior during bubble blowing process in blown extrusion, and Y is the core layer in contact with the outer layers. Both samples have a layer thickness ratio of 1:3:1. Samples were conditioned at 23° C.±2° C. and 50%±10% relative humidity for at least 40 hours prior to determination of all properties. Structure-wise formulations of the film samples, accompanied by test results thereof, are depicted in Table 3.

The test methods used to generate the mechanical property values stated in Table 3, including stretch hood tear propagation, Elmendorf tear and elastic recovery, are described above with respect to Sample 1.

TABLE 3
STRUCTURE-WISE FORMULATIONS (WT %) AND MECHANICAL
PROPERTIES FOR FILM SAMPLES OF EXAMPLE 3

| | Sample No. | |
|---|---|---|
| | 3 | 3a |
| A | EXCEED ™ 1018HA (96.5) | EXCEED ™ 1018HA (38) |
| | POLYBATCH ™ F15 (3.5) | EXCEED ™ 1018LA (60) |
| | | POLYBATCH ™ CE 505E (2) |
| Y | VISTAMAXX ™ 3020FL (60) | NEXXSTAR ™ low EVA- |
| | EXCEED ™ 1012MX (25) | 00111 (98) |
| | LDPE 2420D (15) | POLYBATCH ™ CE 505E (2) |
| A′ | — | EXCEED ™ 1018HA (38) |
| | | EXCEED ™ 1018LA (60) |
| | | POLYBATCH ™ CE 505E (2) |
| Fₘₐₓ at 100% strain | 0.23 | 0.44 |
| (N/μm) | | |
| Elmendorf tear MD | 14.0 | 10.8 |
| (g/μm) | | |
| Elastic recovery (%) | 55.8 | 70.34 |

As shown by test results in Table 3, the inventive Sample 3 outperformed the comparative machine stretch hood film Sample 3a in terms of properties, including a much lower maximum force at 100% strain, a higher tear resistance in MD, and increased elastic recovery, indicating advantages in manual operation ease, sufficient tear resistance in MD to balance emphasized force exerted in MD during manual hooding operation, and improved film behavior during extension and after contraction around a load on a stretch hood packaging line with reduced risk of tearing or puncturing over the conventional machine stretch hood.

Particularly, without being bound by theory, it is believed that the flexibility in adjusting layer composition and structure depending on ethylene content of the propylene-based elastomer used can be exploited to conveniently provide benefits in improving property profile and overall film performance in response to growing demands of different stretch hood applications.

All documents described herein are incorporated by reference herein, including any priority documents and/or testing procedures. When numerical lower limits and numerical upper limits are listed herein, ranges from any lower limit to any upper limit are contemplated. As is apparent from the foregoing general description and the specific embodiments, while forms of the invention have been illustrated and described, various modifications can be made without departing from the spirit and scope of the invention.

What is claimed is:

1. A multilayer film, comprising:
(a) two outer layers, wherein at least one of the outer layers comprises a first polyethylene; and
(b) a core layer between the two outer layers, comprising a first propylene-based elastomer having at least about 60 wt % propylene-derived units and about 3 to about 25 wt % ethylene-derived units, based on total weight of the first propylene-based elastomer, and a heat of fusion of less than about 80 J/g, wherein the first propylene-based elastomer is present in an amount of at least 50 wt %, based on total weight of polymer in the core layer,
wherein the multilayer film has at least one of the following properties: (i) a tensile at break of at least about 40 MPa in the Machine Direction (MD) and of at least about 38 MPa in the Transverse Direction (TD); (ii) a tear propagation of less than or equal to about 10%;
(iii) an elastic recovery of at least about 55%; (iv) a holding force (normalized to 100 μm end) of at least about 22 N/μm; (v) a maximum force at 100% strain of less than or equal to about 0.2 N/μm; and (vi) a tear resistance of at least about 12 g/μm in MD.

2. The multilayer film of claim 1, wherein the first polyethylene is present in an amount of at least about 80 wt %, based on total weight of polymer in the outer layer.

3. The multilayer film of claim 1, wherein the first polyethylene has a density of about 0.900 to about 0.945 g/cm³, a melt index (MI), I_{2.16}, of about 0.1 to about 15 g/10 min, a molecular weight distribution (MWD) of about 1.5 to about 5.5, and a melt index ratio (MIR), I_{21.6}/I_{2.16}, of about 10 to about 100.

4. The multilayer film of claim 1, wherein the ethylene-derived units in the first propylene-based elastomer are present in an amount of at least about 13 wt %, based on total weight of the first propylene-based elastomer.

5. The multilayer film of claim 4, wherein the core layer consists of the propylene-based elastomer.

6. The multilayer film of claim 1, wherein the ethylene-derived units in the first propylene-based elastomer are present in an amount of less than or equal to about 13 wt %, based on total weight of the first propylene-based elastomer.

7. The multilayer film of claim 6, wherein the core layer further comprises at least about 10 wt % of a second polyethylene.

8. The multilayer film of claim 7, wherein the second polyethylene has a branching index of about 0.40 to about 0.45.

9. The multilayer film of claim 1, further comprising two inner layers between the core layer and each outer layer, wherein at least one of the inner layer comprises a second propylene-based elastomer having at least about 60 wt % propylene-derived units and about 3 to about 25 wt % ethylene-derived units, based on total weight of the second propylene-based elastomer, and a heat of fusion of less than about 80 J/g.

10. The multilayer film of claim 9, wherein the ethylene-derived units in the second propylene-based elastomer are present in an amount of at least about 13 wt %, based on total weight of the second propylene-based elastomer.

11. The multilayer film of claim 10, wherein the second propylene-based elastomer is present in an amount of at least about 50 wt %.

12. The multilayer film of claim 9, wherein the ethylene-derived units in the second propylene-based elastomer are present in an amount of less than or equal to about 13 wt %, based on total weight of the second propylene-based elastomer.

13. The multilayer film of claim 12, wherein the second propylene-based elastomer is present in an amount of about 20 wt % to about 50 wt %.

14. The multilayer film of claim 1, wherein the core layer has a thickness of at least about one third of the total thickness of the multilayer film.

15. The multilayer film of claim 1, the multilayer film having a thickness of from about 30 to about 130 μm.

16. The multilayer film of claim 1, wherein at least one layer comprises at least one of a slip agent, an antiblock, a filler, an antioxidant, an ultraviolet light stabilizer, a thermal stabilizer, a pigment, a processing aid, a crosslinking catalyst, a flame retardant, and a foaming agent.

17. A multilayer film, comprising:
(a) two outer layers, each consisting of a blend of two polyethylenes, wherein each of the polyethylenes has a density of about 0.900 to about 0.920 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25;
(b) a core layer between the two outer layers, the core layer comprising at least about 50 wt % of a propylene-based elastomer and at least about 10 wt % of a polyethylene, wherein the propylene-based elastomer has at least about 60 wt % propylene-derived units and about 3 to about 13 wt % ethylene-derived units, based on total weight of the propylene-based elastomer, and a heat of fusion of less than about 80 J/g, wherein the polyethylene has a branching index of about 0.40 to about 0.45; and
(c) two inner layers each between the core layer and each outer layer, each of the inner layer comprising (i) about 20 wt % to about 50 wt % of the propylene-based elastomer in the core layer, and (ii) a polyethylene having a density of about 0.900 to about 0.915 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25, based on total weight of polymer in each inner layer,
wherein the multilayer film has at least one of the following properties: (i) a tensile at break of at least about 40 MPa in MD and of at least about 38 MPa in TD; (ii) a tear propagation of less than or equal to about 10%; (iii) an elastic recovery of at least about 55%; and (iv) a holding force (normalized to 100 μm end) of at least about 22 N/μm.

18. The multilayer film of claim 17, wherein the thickness ratio between each of the outer layers, each of the inner layers, and the core layer is about 1:1:2.

19. The multilayer film of claim 17, the multilayer film having a thickness of from about 50 to about 100 μm.

20. A stretch hood film comprising the multilayer film of claim 1.

21. A method for making a multilayer film, comprising the steps of:
(a) preparing two outer layers, wherein at least one of the outer layers comprises a first polyethylene;
(b) preparing a core layer between the two outer layers, comprising a first propylene-based elastomer having at least about 60 wt % propylene-derived units and about 3 to about 25 wt % ethylene-derived units, based on total weight of the first propylene-based elastomer, and a heat of fusion of less than about 80 J/g, wherein the first propylene-based elastomer is present in an amount of at least 50 wt %, based on total weight of polymer in the core layer; and
(c) forming a film comprising the layers in steps (a) and (b),
wherein the multilayer film has at least one of the following properties: (i) a tensile at break of at least about 40 MPa in the Machine Direction (MD) and of at least about 38 MPa in the Transverse Direction (TD); (ii) a tear propagation of less than or equal to about 10%;
(iii) an elastic recovery of at least about 55%; (iv) a holding force (normalized to 100 μm end) of at least about 22 N/μm; (v) a maximum force at 100% strain of less than or equal to about 0.2 N/μm; and (vi) a tear resistance of at least about 12 g/μm in MD.

22. The method of claim 21, further comprising a step between step (b) and step (c) of preparing two inner layers each between the core layer and each outer layer, wherein at least one of the inner layer comprises a second propylene-based elastomer having at least about 60 wt % propylene-derived units and about 3 to about 25 wt % ethylene-derived units, based on total weight of the second propylene-based elastomer, and a heat of fusion of less than about 80 J/g.

23. A stretch hood film made according to the method of claim 21.
